(19) United States
(12) Patent Application Publication
(10) Pub. No.: US 2026/0161236 A1
(43) Pub. Date: Jun. 11, 2026

(54) INFORMATION PROCESSING APPARATUS AND INFORMATION PROCESSING SYSTEM

(71) Applicant: SONY GROUP CORPORATION, Tokyo (JP)

(72) Inventors: Naoya SAZUKA, Tokyo (JP); Koki KATSUMATA, Kanagawa (JP)

(73) Assignee: SONY GROUP CORPORATION, Tokyo (JP)

(21) Appl. No.: 19/127,074

(22) PCT Filed: Oct. 31, 2023
(86) PCT No.: PCT/JP2023/039182

§ 371 Date: May 2, 2025

(30) Foreign Application Priority Data
Nov. 18, 2022 (JP) 2022-184667

(51) Int. Cl. G06F 3/01

(52) U.S. Cl. CPC G06F 3/017; G06F 3/011; G06F 2203/011

(57) ABSTRACT

An information processing apparatus includes a body movement detector that detects movement of a body of a person using data obtained by a sensor, and a comfort-or-discomfort determination section that determines a comfortable or uncomfortable state of the person on the basis of the detected body movement.

### TECHNICAL FIELD

The present disclosure relates to an information processing apparatus and an information processing system, and, in particular, to an information processing apparatus and an information processing system that make it possible to estimate, using a simpler method, a comfortable or uncomfortable state of a person that corresponds to an internal condition of the person.

### BACKGROUND ART

In general, it is very difficult to determine an internal condition of a person, that is, whether the person feels comfortable or uncomfortable. For example, a technology is proposed that is used to estimate whether a person feels comfortable or uncomfortable on the basis of biological information such as brain waves and a heartbeat (refer to, for example, Patent Literature 1). Further, there is also a technology that is used to estimate, using facial expression, whether a person feels comfortable or uncomfortable (refer to, for example, Non-Patent Literature 1).

The use of biological information such as brain waves may make it possible to estimate a comfortable or uncomfortable state of a person in detail. However, when brain waves are measured, there is currently a need to perform wearable measurement by, for example, attaching an electroencephalograph to a head.

### CITATION LIST

### Patent Literature

Patent Literature 1: WO 2022/209499

### Non-Patent Literature

Non-Patent Literature 1: Lyons, Michael J., Julien Budynek, and Shigeru Akamatsu. “Automatic classification of single facial images.” IEEE transactions on pattern analysis and machine intelligence 21.12 (1999): 1357-1362.

### DISCLOSURE OF INVENTION

### Technical Problem

The present disclosure has been made in view of the circumstances described above, and it is an object of the present disclosure to makes it possible to estimate, using a simpler method, a comfortable or uncomfortable state of a person that corresponds to an internal condition of the person.

### Solution to Problem

An information processing apparatus according to a first aspect of the present disclosure includes a detector that detects movement of a body of a person using data obtained by a sensor, and a determination section that determines a comfortable or uncomfortable state of the person on the basis of the detected body movement.

An information processing system according to a second aspect of the present disclosure includes a device that includes a sensor, a detector that detects movement of a body of a person using data obtained by the sensor, a determination section that determines a comfortable or uncomfortable state of the person on the basis of the detected body movement, and an output section that performs a specified output based on a result of the determination.

In the first and second aspects of the present disclosure, movement of a body of a person is detected using data obtained by a sensor, and a comfortable or uncomfortable state of the person is determined on the basis of the detected body movement.

Each of the information processing apparatus and the information processing system may be an independent apparatus, or may be a module that is incorporated into another apparatus.

### BRIEF DESCRIPTION OF DRAWINGS

FIG. 1 is a diagram used to describe a relationship between movement of a body of a person and a comfortable or uncomfortable state of the person.

FIG. 2 is a diagram used to describe the relationship between movement of a body of a person and a comfortable or uncomfortable state of the person.

FIG. 3 is a block diagram of an example of a configuration of an information processing apparatus of a first embodiment, where the present technology is applied to the information processing apparatus.

FIG. 4 is a flowchart used to describe first comfort-or-discomfort determination processing performed by the information processing apparatus illustrated in FIG. 3.

FIG. 5 is a flowchart used to describe second comfort-or-discomfort determination processing performed by the information processing apparatus illustrated in FIG. 3.

FIG. 6 is a diagram used to describe an example of an application that performs the comfort-or-discomfort determination processing.

FIG. 7 is a diagram used to describe another method for determining a threshold.

FIG. 8 is a block diagram of an example of a configuration of an information processing system of a second embodiment, where the present technology is applied to the information processing system.

FIG. 9 is a block diagram of an example of a configuration of an information processing system of a third embodiment, where the present technology is applied to the information processing system.

FIG. 10 is a flowchart used to describe third comfort-or-discomfort determination processing performed by the information processing system illustrated in FIG. 9.

FIG. 11 is a flowchart used to describe fourth comfort-or-discomfort determination processing performed by the information processing system illustrated in FIG. 9.

FIG. 12 is a block diagram of an example of a configuration of the information processing system according to a modification of the third embodiment.

FIG. 13 illustrates an example in which a wearable device is a head-mounted display.

FIG. 14 illustrates an example in which the wearable device is a headband.

FIG. 15 illustrates an example in which the wearable device is headphones.

FIG. 16 illustrates an example in which the wearable device is an earphone.

FIG. 17 illustrates an example in which the wearable device is a watch.

FIG. 18 illustrates an example in which the wearable device is smart glasses.

FIG. 19 illustrates an example in which the wearable device is a headset.

FIG. 20 illustrates an example in which the wearable device is a mask.

FIG. 21 is a block diagram of an example of a hardware configuration when the information processing apparatus includes a computer.

### MODE(S) FOR CARRYING OUT THE INVENTION

Embodiments for carrying out the technology of the present disclosure (hereinafter referred to as “embodiments”) will now be described below with reference to the accompanying drawings. Note that, in the specification and the drawings, structural elements having substantially the same functional configuration are denoted by the same reference numeral to omit a repetitive description. The description is made in the following order.
1. Relationship Between Movement of Body of Person and Comfortable or Uncomfortable State of Person
2. First Embodiment
3. Second Embodiment
4. Third Embodiment
5. Modification of Third Embodiment
6. Examples of Wearable Devices
7. Example of Configuration of Computer

### 1. Relationship Between Movement of Body of Person and Comfortable or Uncomfortable State of Person

An information processing apparatus of the present disclosure is an apparatus that detects movement of a body of a person to determine (estimate) an internal condition of the person that corresponds to a comfortable or uncomfortable feeling of the person. First, relationship between movement of a body of a person and an internal condition of the person that corresponds to a comfortable or uncomfortable state of the person is described, where the relationship has been revealed by the experiments performed by the inventors.

The inventors collected a specified number of subjects, and performed experiment in which the subjects were given information that causes the subjects to be in a comfortable state or in an uncomfortable state (hereinafter referred to as a comfortable or uncomfortable state) to determine a comfortable or uncomfortable state of a person that corresponds to an internal condition of the person and to detect movement of a body of the person. The comfortable or uncomfortable state was determined using a distinction model (hereinafter referred to as a biological distinction model) used to determine (estimate), using biological information such as brain waves and heartbeat, an internal condition of a person that corresponds to a comfortable or uncomfortable feeling of the person. An existing estimation model was used as the biological distinction model, where it is known that determination can be performed with a specified degree of accuracy in estimation using the existing estimation model. A head of a person was observed for movement of a body of the person, and movement of the head of the person was detected using an acceleration sensor that serves as a wearable sensor. It was confirmed with the subjects whether the subjects themselves were aware of being in a comfortable state or in an uncomfortable state in order to verify a determination result.

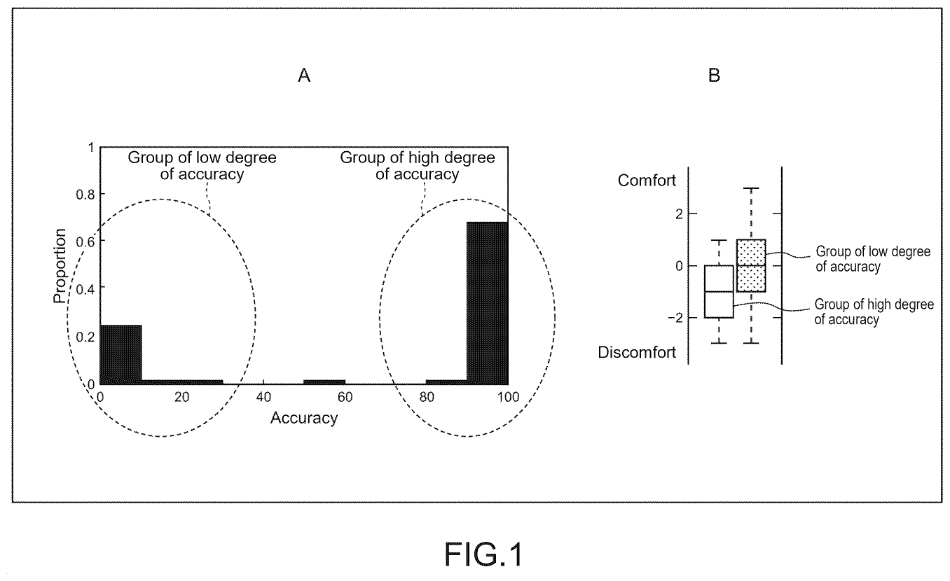

A of FIG. 1 is a graph obtained by adding up percentages of correct answers (Accuracy) given by a biological distinction model. A horizontal axis of the graph represents a percentage of correct answers, and a vertical axis of the graph represents a proportion of the number of subjects. A result of the experiment shows that there were a group of a high degree of accuracy in estimation performed by a biological distinction model and a group of a low degree of accuracy in the estimation, as illustrated in A of FIG. 1.

B of FIG. 1 is a graph obtained by adding up subjects'uncomfortable states of which the subjects themselves were aware when an estimation result was an uncomfortable state for each of the group of a high degree of accuracy in estimation performed by the biological distinction model and the group of a low degree of accuracy in the estimation. A vertical axis represents a level of a comfortable or uncomfortable state, where “0” represents neutrality, a positive number represents a comfortable state, and a negative number represents an uncomfortable state. A result of the adding up shows that a person with a higher estimation accuracy subjectively felt more uncomfortable. This verified the accuracy of the biological distinction model.

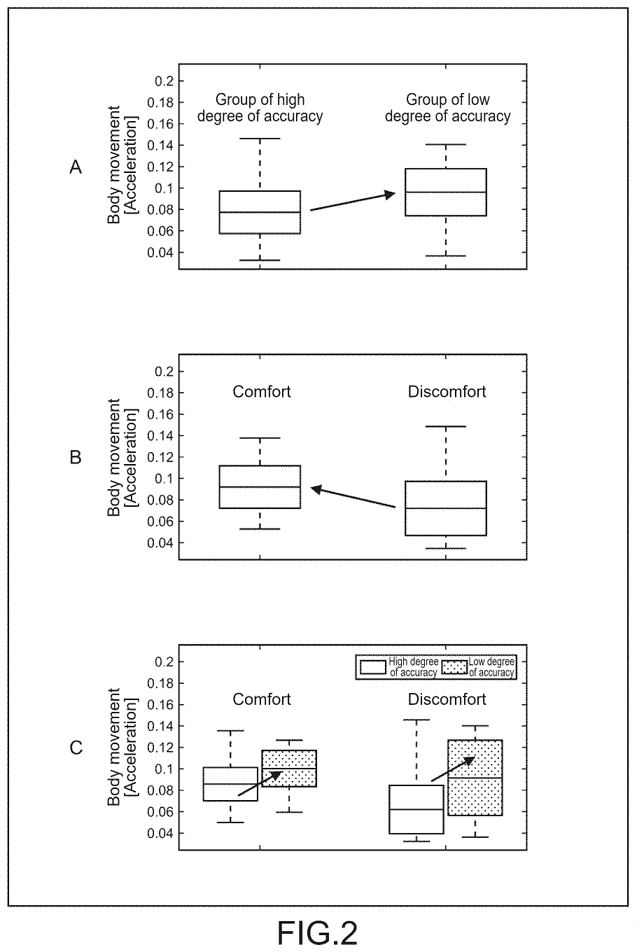

A of FIG. 2 is a graph in which a result of measuring movement of a body (movement of a head) of a person is given for each of a group of a high degree of accuracy in estimation performed by a biological distinction model and a group of a low degree of accuracy in the estimation. As can be seen from this, when a level of movement of a body of a person with a high degree of accuracy in estimation performed by a biological distinction model is compared with a level of movement of a body of a person with a low degree of accuracy in the estimation, the person with a low degree of accuracy in estimation performed by the biological distinction model has a greater body movement (acceleration) than the person with a high degree of accuracy in estimation performed by the biological distinction model.

B of FIG. 2 is a graph in which a result of measuring movement of a body (movement of a head) of a person in each of a comfortable state and an uncomfortable state is given. As can be seen from this, a person has a greater body movement in a comfortable state than in an uncomfortable state. The reason is that the uncomfortable state leads to a person being immobile (what is called being frozen). There is a need to consider the fact that a person in a comfortable state may also be excluded if a person with a greater acceleration is excluded in order to exclude the case of a low estimation accuracy in consideration of the result of A of FIG. 2.

As can be seen from a result in B of FIG. 2, a body movement performed in a comfortable state is large, and a body movement performed in an uncomfortable state is small. Thus, a comfortable or uncomfortable state can be simply determined by detecting movement of a body of a person. For example, a specified threshold (for example, 0.07 [m/s²]) used to distinguish a comfortable state from an uncomfortable state may be determined on the basis of a distribution of acceleration for a group determined to be in a comfortable state or in an uncomfortable state. Then, a person may be determined to be in a comfortable state when acceleration measured to be a body movement is greater than the specified threshold determined in advance, and the person may be determined to be in an uncomfortable state when the acceleration is less than or equal to the specified threshold. The measurement of a body movement is easier than detection of facial expression that has been performed in the past and measurement of biological information, and can be performed with a simple configuration of an apparatus. However, there is a need for the time order of several minutes in order to measure acceleration sufficiently for determination.

C of FIG. 2 is a graph in which a result of measuring movement of a body (movement of a head) of a person in each of a comfortable state and an uncomfortable state is given for each of a group of a high degree of accuracy in estimation performed by a biological distinction model and a group of a low degree of accuracy in the estimation. As can be seen from this, in both of a comfortable state and an uncomfortable state, a person with a low degree of accuracy in estimation performed by a biological distinction model has a greater body movement (acceleration) than a person with a high degree of accuracy in the estimation.

As can be seen from C of FIG. 2, the accuracy in estimation performed by a biological distinction model can be increased by using information regarding movement of a body of a person as context (a selection condition). When, for example, a person with a great acceleration is excluded or noise is reduced depending on a magnitude of acceleration, this makes it possible to increase the accuracy in estimation performed by a biological distinction model. Further, when a threshold (a first threshold) used to determine whether a person is in a comfortable state and a threshold (a second threshold) used to determine whether the person is in an uncomfortable state are set to different values with respect to acceleration used to detect movement of a body of a person, this makes it possible to increase the accuracy in estimation performed by a biological distinction model. For example, the first threshold used to determine whether a person is in a comfortable state may be set to be greater than 0.08, and the second threshold used to determine whether the person is in an uncomfortable state may be set to be less than or equal to 0.06.

### 2. First Embodiment

### (Block Diagram)

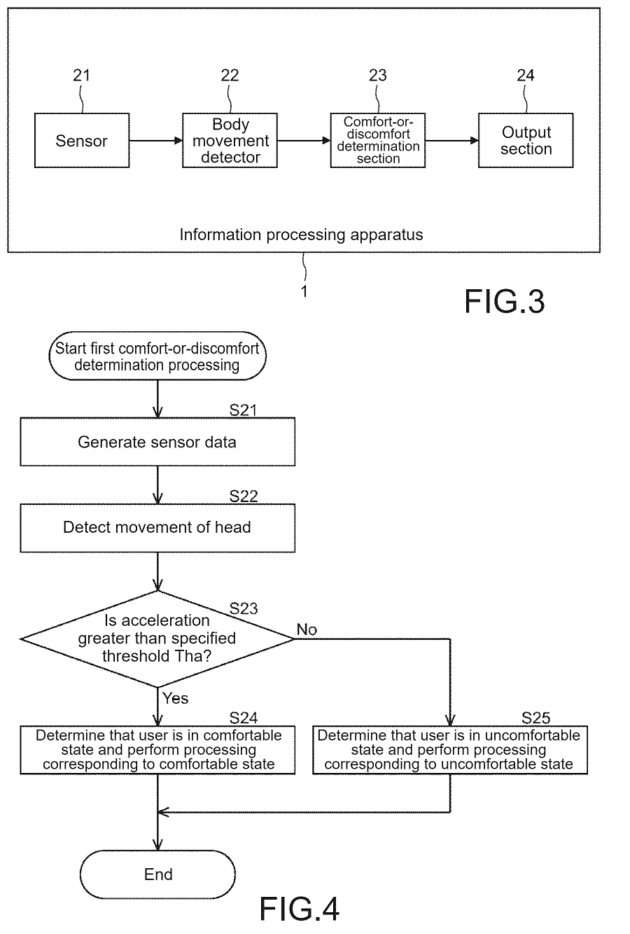

FIG. 3 is a block diagram of an example of a configuration of an information processing apparatus of a first embodiment, where the present technology is applied to the information processing apparatus.

An information processing apparatus 1 illustrated in FIG. 3 is an apparatus that detects movement of a body of a person to determine (estimate) an internal condition of the person that corresponds to a comfortable or uncomfortable feeling of the person. In the present embodiment, the information processing apparatus 1 detects movement of a head of a person as movement of a body of the person. The information processing apparatus 1 includes a sensor 21, a body movement detector 22, a comfort-or-discomfort determination section 23, and an output section 24. A determination target for determination of a comfortable or uncomfortable state is also referred to as a user as appropriate.

The sensor 21 is a sensor that generates sensor data that enables the body movement detector 22 to detect movement of a body (an amount of movement of the body) of a user, and outputs the generated sensor data to the body movement detector 22. The sensor 21 is, for example, a wearable sensor attached to a head of a user, and may be an acceleration sensor that detects acceleration. In this case, the sensor 21 outputs data of the detected acceleration to the body movement detector 22. Further, the sensor 21 may be, for example, an image sensor such as a charge-coupled device (CCD) sensor or a complementary metal-oxide semiconductor (CMOS) sensor. In this case, the sensor 21 outputs data of an image of a user to the body movement detector 22 as the sensor data. The sensor 21 may be any sensor that can detect an amount of movement of a body of a user, and may be, for example, a speed sensor or a gyroscope (an angular velocity sensor).

The body movement detector 22 detects movement of a body of a user using sensor data supplied by the sensor 21. In the present embodiment, an amount of movement of a head of a user is detected in the form of acceleration as the movement of the body of the user. When, for example, the sensor 21 is an acceleration sensor, the body movement detector 22 calculates an average of accelerations for a specified period of time determined in advance (for example, for several minutes) to detect acceleration of a head of a user. When, for example, the sensor 21 is an image sensor, the body movement detector 22 tracks a position of a head of a user for a specified period of time determined in advance (for example, for several minutes), using image recognition to detect acceleration of the head of the user. The body movement detector 22 outputs the detected acceleration of the head of the user to the comfort-or-discomfort determination section 23.

The comfort-or-discomfort determination section 23 determines a comfortable or uncomfortable state of a user on the basis of acceleration of a head of the user that is supplied by the body movement detector 22. When, for example, one threshold is used to determine the comfortable or uncomfortable state, the comfort-or-discomfort determination section 23 determines that the user is in a comfortable state when acceleration supplied by the body movement detector 22 is greater than a specified threshold Tha, and the comfort-or-discomfort determination section 23 determines that the user is in an uncomfortable state when the acceleration is less than or equal to the specified threshold Tha. Further, when different thresholds are set to be a first threshold Thb1 used to determine whether a user is in a comfortable state and a second threshold Thb2 (Thb1>Thb2) used to determine whether the user is in an uncomfortable state, the comfort-or-discomfort determination section 23 determines that the user is in a comfortable state when acceleration supplied by the body movement detector 22 is greater than the first threshold Thb1, and the comfort-or-discomfort determination section 23 determines that the user is in an uncomfortable state when the acceleration is less than or equal to the second threshold Thb2. The specified threshold Tha, the first threshold Thb1, and the second threshold Thb2 are determined on the basis of past data obtained by, for example, the experiments described above. The comfort-or-discomfort determination section 23 outputs, to the output section 24, determination data that indicates a result of the determination.

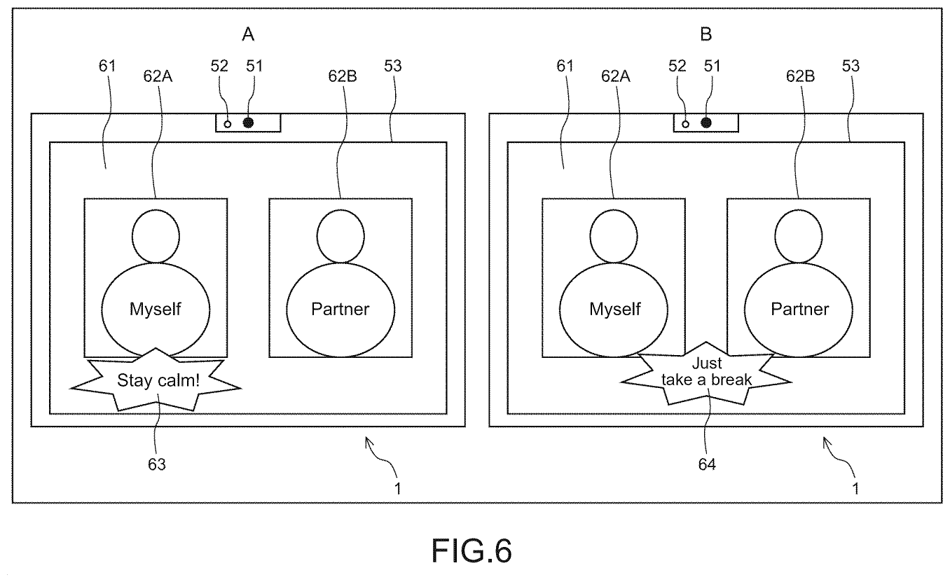

The output section 24 performs a specified output based on a determination result supplied by the comfort-or-discomfort determination section 23. Examples of the output section 24 include a display apparatus such as a liquid crystal display or organic EL display that displays thereon a video, a speaker that outputs, for example, sound, a buzzing sound, and chimes, and an illumination apparatus that is lit in a specified color. The output section 24 outputs words, a video, sound, or illumination (light in a specified color) that corresponds to a comfortable state or uncomfortable state that is a determination result so that the output section 24 can report to a user that the user is in a comfortable state or in an uncomfortable state. Further, using, for example, vibration or scent, the output section 24 may report to a user that the user is in a comfortable state or uncomfortable state that is a determination result. Alternatively, the output section 24 may perform conversion into instruction information regarding an instruction given to a user, and may perform output in the form of, for example, words, a video, or sound, where the instruction information is information, such as “Stay calm” and “Take a break” in an example illustrated in FIG. 6 and described later, that corresponds to a comfortable state or an uncomfortable state.

The information processing apparatus 1 has the configuration described above, and can determine (estimate) a comfortable or uncomfortable state of a person by detecting movement of a head of the person. The information processing apparatus 1 may be a dedicated apparatus that determines a comfortable or uncomfortable state of a person. Alternatively, the information processing apparatus 1 may be, for example, a personal computer, a smartphone, a tablet, a cellular phone, a game machine, a television set, a head-mounted display (HMD), a wearable device such as smart glasses, a digital still camera, or a digital video camera.

### (Flowchart of First Comfort-or-Discomfort Determination Processing)

First comfort-or-discomfort determination processing performed by the information processing apparatus 1 is described with reference to a flowchart in FIG. 4. The first comfort-or-discomfort determination processing is an example of comfort-or-discomfort determination processing when one threshold is used to determine a comfortable or uncomfortable state. For example, this processing is started when the information processing apparatus 1 is turned on or when an operation to start the comfort-or-discomfort determination processing is performed by a user.

First, in Step S21, the sensor 21 performs sensing on a user to generate sensor data, and outputs the generated sensor data to the body movement detector 22. When the sensor 21 is an acceleration sensor, data of detected acceleration is output to the body movement detector 22.

When the sensor 21 is an image sensor, image data of a user image of the user is output to the body movement detector 22.

In Step S22, the body movement detector 22 detects movement of a head of the user as movement of a body of the user using the sensor data supplied by the sensor 21. Specifically, when the sensor 21 is an acceleration sensor, the body movement detector 22 calculates an average of accelerations for a specified period of time to detect acceleration of the head of the user. When, for example, the sensor 21 is an image sensor, the body movement detector 22 tracks a position of the head of the user for a specified period of time using image recognition to detect the acceleration of the head of the user. The body movement detector 22 outputs the detected acceleration of the head of the user to the comfort-or-discomfort determination section 23.

In Step S23, the comfort-or-discomfort determination section 23 determines whether the acceleration of the head of the user is greater than a specified threshold Tha, the acceleration being supplied by the body movement detector 22.

When the acceleration of the head of the user has been determined to be greater than the specified threshold Tha in Step S23, the process moves on to Step S24, the comfort-or-discomfort determination section 23 determines that the user is in a comfortable state, and outputs, to the output section 24, determination data that indicates a result of the determination. The output section 24 acquires the determination data, and performs processing corresponding to the comfortable state. For example, a message image of, for example, “comfortable state” is displayed on a display apparatus that serves as the output section 24.

On the other hand, when the acceleration of the head of the user has been determined to be less than or equal to the specified threshold Tha in Step S23, the process moves on to Step S25, the comfort-or-discomfort determination section 23 determines that the user is in an uncomfortable state, and outputs, to the output section 24, determination data that indicates a result of the determination. The output section 24 acquires the determination data, and performs processing corresponding to the uncomfortable state. For example, a message image of, for example, “uncomfortable state” is displayed on the display apparatus serving as the output section 24.

The first comfort-or-discomfort determination processing is performed as described above. The first comfort-or-discomfort determination processing makes it possible to estimate, using a simpler method, a comfortable or uncomfortable state of a person that corresponds to an internal condition of the person. This first comfort-or-discomfort determination processing may be performed repeatedly until an operation to terminate the processing is performed by the user.

### (Flowchart of Second Comfort-or-Discomfort Determination Processing)

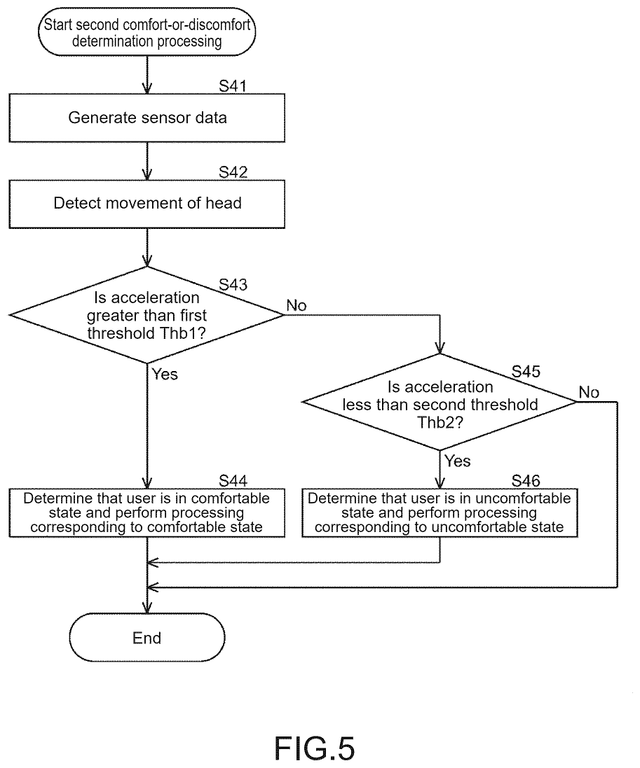

Next, second comfort-or-discomfort determination processing performed by the information processing apparatus 1 is described with reference to a flowchart in FIG. 5. The second comfort-or-discomfort determination processing is an example of the comfort-or-discomfort determination processing when two thresholds are used to determine a comfortable or uncomfortable state. For example, this processing is started when the information processing apparatus 1 is turned on or when an operation to start the comfort-or-discomfort determination processing is performed by a user.

First, in Step S41, the sensor 21 performs sensing on a user to generate sensor data, and outputs the generated sensor data to the body movement detector 22. In Step S42, the body movement detector 22 detects movement of a head of the user as movement of a body of the user using the sensor data supplied by the sensor 21. The processes of Steps S41 and S42 are similar to the processes of Steps S21 and S22 of the first comfort-or-discomfort determination processing described above.

In Step S43, the comfort-or-discomfort determination section 23 determines whether the acceleration of the head of the user is greater than a first threshold Thb1, the acceleration being supplied by the body movement detector 22.

When the acceleration of the head of the user has been determined to be greater than the first threshold Thb1 in Step S43, the process moves on to Step S44, the comfort-or-discomfort determination section 23 determines that the user is in a comfortable state, and outputs, to the output section 24, determination data that indicates a result of the determination. The output section 24 acquires the determination data, and performs processing corresponding to the comfortable state. For example, a message image of, for example, “comfortable state” is displayed on a display apparatus that serves as the output section 24.

On the other hand, when the acceleration of the head of the user has been determined to be less than or equal to the first threshold Thb1 in Step S43, the process moves on to Step S45, and the comfort-or-discomfort determination section 23 determines whether the acceleration of the head of the user is less than a second threshold Thb2. When the acceleration of the head of the user has been determined to be less than the second threshold Thb2 in Step S45, the process moves on to Step S46, the comfort-or-discomfort determination section 23 determines that the user is in an uncomfortable state, and outputs, to the output section 24, determination data that indicates a result of the determination. The output section 24 acquires the determination data, and performs processing corresponding to the uncomfortable state. For example, a message image of, for example, “uncomfortable state” is displayed on the display apparatus serving as the output section 24.

On the other hand, when the acceleration of the head of the user has been determined to be greater than or equal to the second threshold Thb2 in Step S45, the comfort-or-discomfort determination section 23 terminates the second comfort-or-discomfort determination processing.

The second comfort-or-discomfort determination processing is performed as described above. The second comfort-or-discomfort determination processing makes it possible to estimate, using a simpler method, a comfortable or uncomfortable state of a person that corresponds to an internal condition of the person. This second comfort-or-discomfort determination processing may be performed repeatedly until an operation to terminate the processing is performed by the user. The second comfort-or-discomfort determination processing in which different thresholds are set to be the first threshold Thb1 used to determine whether a user is in a comfortable state and the second threshold Thb2 used to determine whether the user is in an uncomfortable state, makes it possible to increase the accuracy in estimation, compared with the first comfort-or-discomfort determination processing used to determine whether the user is in a comfortable state or in an uncomfortable state using one threshold Tha.

### (Example of Use in Application)

Next, an example of an application that performs the comfort-or-discomfort determination processing is described with reference to FIG. 6.

In FIG. 6, the information processing apparatus 1 is, for example, a personal computer, and a calling app 61 that enables a video call with another user is executed on the personal computer. The calling app 61 includes the body movement detector 22 and the comfort-or-discomfort determination section 23, and serves to determine the comfortable or uncomfortable state described above. A camera 51, a microphone 52, and a display 53 are provided to the personal computer serving as the information processing apparatus 1. The camera 51 corresponds to the sensor 21 in FIG. 1, and the display 53 corresponds to the output section 24 in FIG. 1. The information processing apparatus 1 may be a smartphone instead of a personal computer.

The display 53 of the calling app 61 displays thereon an image 62A of a user (myself), and an image 62B of another user (a partner at the other end of the line), where the image 62A is captured using the camera 51, and the image 62B is transmitted from another apparatus (information processing apparatus 1) through a specified communication line such as the Internet. Using the image 62A of the user (myself) that is captured using the camera 51, the calling app 61 detects movement of a head of the user, and performs comfort-or-discomfort determination processing to determine a comfortable or uncomfortable state of the user. Further, using the image 62B of the other user (the partner at the other end of the line), the calling app 61 detects movement of a head of the partner at the other end of the line, and performs comfort-or-discomfort determination processing to determine a comfortable or uncomfortable state of the partner at the other end of the line.

When the user situated in front of the camera 51 has been determined to be in an uncomfortable state using the comfort-or-discomfort determination processing, the calling app 61 causes a message 63 of “Stay calm!” to be displayed on a screen as instruction information regarding an instruction given to the user, as illustrated in an example in A of FIG. 6. When a comfortable or uncomfortable state is determined in real time and an instruction based on the comfortable or uncomfortable state is fed back to a user, as described above, this enables the user to stay calm.

When both the user situated in front of the camera 51 and the partner at the other end of the line have been determined to be in an uncomfortable state using the comfort-or-discomfort determination processing, the calling app 61 causes a message 64 of “Just take a break” to be displayed on the screen as instruction information regarding an instruction given to the user, as illustrated in an example in B of FIG. 6, where the message 64 encourages the user to take a break. Likewise, a calling app of an apparatus on the side of the partner at the other end of the line causes a message of “Just take a break” to be displayed. When a comfortable or uncomfortable state is determined in real time and an instruction based on the comfortable or uncomfortable state is fed back to a user, as described above, this makes it possible to encourage both a user and a partner at the other end of the line to take a break.

### (Extraction of Data of Body Movement During Speech)

The above-described experiments carried out to examine a relationship between a comfortable or uncomfortable state and a body movement have shown that a body movement (especially a head) corresponding to a comfortable or uncomfortable state is more likely to appear especially when a person is speaking. Thus, for example, the calling app 61 may specify a period of time for which a user (myself) and a partner at the other end of the line are speaking, using a sound signal of the user and a sound signal of the partner at the other end of the line, and may determine comfortable or uncomfortable states only with respect to movement (acceleration) of a head of the speaking user and movement (acceleration) of a head of the speaking partner at the other end of the line, where the sound signal of the user is input by the microphone 52 serving as a sound input section, and the sound signal of the partner at the other end of the line is transmitted by the calling app 61 of the partner at the other end of the line.

### (Another Method for Determining Threshold)

In the example described above, a threshold used to determine a comfortable state and an uncomfortable state on the basis of distributions of accelerations for a group determined to be in a comfortable state and for a group determined to be in an uncomfortable state. However, the threshold used to determine a comfortable state and an uncomfortable state may be determined by another method.

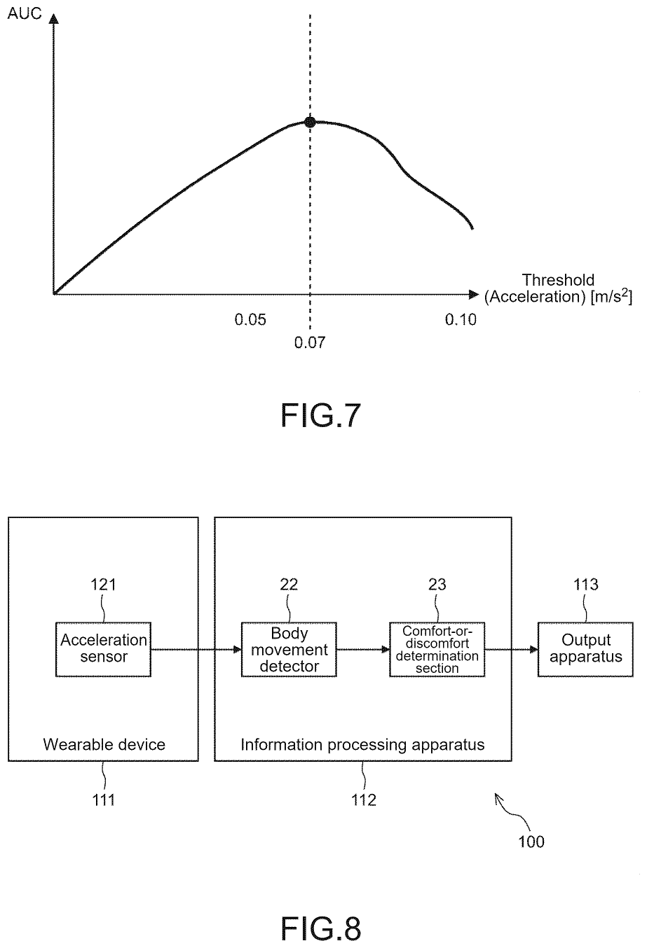

As illustrated in, for example, FIG. 7, various values may be set to be a threshold (acceleration) to determine a comfortable or uncomfortable state, an area under the ROC curve (AUC) may be calculated from a result of the determination, and a threshold with which the AUC is maximum may be determined to be a threshold used for the comfort-or-discomfort determination processing. The AUC is an area under the ROC curve obtained from sensitivity and a false positive rate (1—specificity) of a distinction model. In the example illustrated in FIGS. 7, 0.07 [m/s²] is determined to be the threshold.

### (Detection of Movement of Body Except for Head)

In the first embodiment described above, a head of a user is observed to detect movement of the head when a magnitude of movement of a body of the user is detected. However, the magnitude of the body movement may be detected using a body part except for the head or a portion of the body that includes the head, where the body part except for the head includes a whole body, an upper body, a neck, and a wrist of the user.

### (Threshold Update Corresponding to User)

In the first embodiment described above, a comfortable or uncomfortable state is determined by comparing a magnitude of movement of a body of a user to a specified threshold set in advance. The information processing apparatus 1 may be configured such that a threshold used to determine a comfortable or uncomfortable state can be updated using past data of a determination-target user. For example, data of detected acceleration of a head of a user is accumulated in a storage including a semiconductor memory or a hard disk, and a user's comfortable or uncomfortable state of which the user is aware can be fed back using, for example, an operation button when the output section 24 outputs a result of determination of a comfortable or uncomfortable state and when the output determination result is different from the user's comfortable or uncomfortable state of which the user is aware. Data of acceleration different from acceleration obtained for a user's comfortable or uncomfortable state of which the user is aware is excluded due to the feedback, and this results in updating a threshold used to determine a comfortable or uncomfortable state. Alternatively, for example, a calibration mode used to determine a threshold used to determine a comfortable or uncomfortable state, may be provided to enable a user to set or update the threshold at any timing.

### (Other Use Examples)

The comfort-or-discomfort determination processing may be applied to, for example, the following cases.
The comfort-or-discomfort determination processing can be used to check if a determination target is enjoying replying at an interview of, for example, a company or in, for example, a training of NASA or FBI.
Movements of bodies of students are detected in an online class or in a class at a classroom, and the comfort-or-discomfort determination processing is performed to obtain an indicator used to determine whether the students are enjoying listening in class. This makes it possible to help improve a performance in class.
An image of a user who is having a talk is recorded, and the comfort-or-discomfort determination processing is performed on the image. This enables the user to check his/her own talk off-line and to use it as a talk training that helps in feedback.
The comfort-or-discomfort determination processing is performed on a partner who is situated at the other end of the line and with whom a user is having a talk in real time. This enables the user to correct contents of his/her talk by reflecting the comfortable or uncomfortable state of the partner in the contents.
The comfort-or-discomfort determination processing is performed on a player who is playing a game to determine a comfortable or uncomfortable state of the player. A result of the determination can be reflected in game creation by, for example, excluding a scene in which the player is in an uncomfortable state frequently.
The comfort-or-discomfort determination processing is performed on a user who is listening to music. This makes it possible to, for example, reflect a result of the determination of comfort or discomfort in a play list. With respect to an individual user, movement of a head of the user can be detected using an acceleration sensor attached to headphones or an earphone. With respect to a large number of users at, for example, a concert, a comfortable or uncomfortable state may be determined by macroscopically detecting movement of the entirety of audience (users) in an image of a hall that is captured using a camera, or by extracting a specified number of members of the audience from the image.

### 3. Second Embodiment

### (Block Diagram)

FIG. 8 is a block diagram of an example of a configuration of an information processing system of a second embodiment, where the present technology is applied to the information processing system. In FIG. 8, a portion corresponding to that in the first embodiment described above is denoted by the same reference numeral as the first embodiment, and a description thereof is omitted as appropriate.

In the first embodiment described above, a function of determining an internal condition of a person that corresponds to a comfortable or uncomfortable feeling of the person is provided only by the information processing apparatus 1 that is a single apparatus. However, in the second embodiment, the function of determining an internal condition of a person that corresponds to a comfortable or uncomfortable feeling of the person is provided by an information processing system that includes a plurality of apparatuses.

An information processing system 100 of the second embodiment that is illustrated in FIG. 8 includes a wearable device 111, an information processing apparatus 112, and an output apparatus 113.

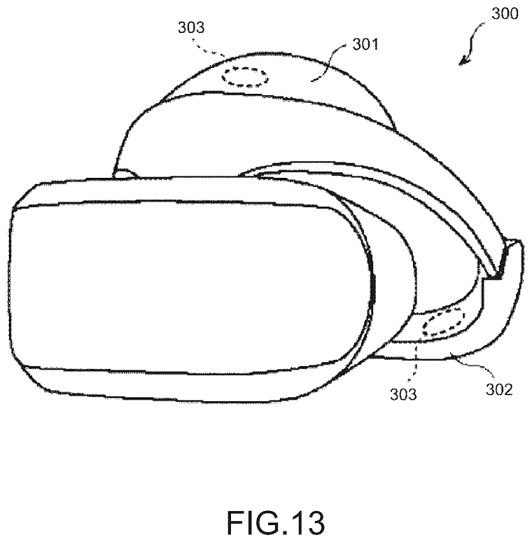

The wearable device 111 includes an acceleration sensor 121. The acceleration sensor 121 is an example of a sensor that can detect movement of a body of a user, and corresponds to the sensor 21 of the first embodiment. Thus, the sensor included in the wearable device 111 may be a sensor, such as a gyroscope, a speed sensor, or an image sensor, that is other than the acceleration sensor 121. When an image sensor is used, this makes it possible to detect movement of a body of a user using, for example, an amount of movement of a surrounding object, where the image sensor is attached outwardly to capture an image of the surrounding object. In the second embodiment, an example of including the acceleration sensor 121 is described for simplification. The acceleration sensor 121 detects movement of a body of a user in the form of acceleration, and outputs data of the detected acceleration to the information processing apparatus 112 as sensor data. The wearable device 111 is, for example, an earphone, headphones, a headset, a head-mounted display (HMD), smart glasses, or a mask. The wearable device 111 may be attached to a user in the form of glasses, an earring, a hair ornament, a mask, a finger ring, a headband, a wristband, or a chest band. Specific examples of the wearable device 111 will be described later with reference to FIGS. 13 to 20.

The information processing apparatus 112 includes the body movement detector 22 and the comfort-or-discomfort determination section 23. The body movement detector 22 and the comfort-or-discomfort determination section 23 are similar to those of the first embodiment, and thus descriptions thereof are omitted.

The output apparatus 113 performs a specified output based on a determination result supplied by the comfort-or-discomfort determination section 23 of the information processing apparatus 112. The output apparatus 113 corresponds to the output section 24 of the first embodiment, which is separated to be an independent apparatus. The output apparatus 113 may be, for example, a display apparatus, a speaker, an illumination apparatus, or a vibrational apparatus.

Comfort-or-discomfort determination processing performed by the information processing system 100 is similar to the first comfort-or-discomfort determination processing and second comfort-or-discomfort determination processing described in the first embodiment, and thus a description thereof is omitted.

### 4. Third Embodiment

Next, an information processing system of a third embodiment is described, where the present technology is applied to the information processing system.

The information processing system of the third embodiment is a system that determines a comfortable or uncomfortable state of a person by combining comfort-or-discomfort determination processing using a biological distinction model used to determine a comfortable or uncomfortable state of a person using biological information, and comfort-or-discomfort determination processing performed to determine the comfortable or uncomfortable state by detecting movement of a body of the person in the form of acceleration.

### (Biological Distinction Model Using Biological Information)

First, a biological distinction model used to determine a comfortable or uncomfortable state of a person using biological information is described.

The comfortable or uncomfortable state of a person can be derived on the basis of biological information regarding the person having a talk with his/her communication partner. Examples of the biological information with which a comfortable or uncomfortable state of a person can be derived include brain waves, sweating, and facial expression.

### (Brain Waves)

It is known that a comfortable or uncomfortable state of a person can be estimated from a difference in alpha waves included in brain waves between right and left portions of a forehead. Thus, for example, alpha waves included in brain waves obtained in a left portion of a forehead (hereinafter referred to as “alpha waves on the left”) are compared with alpha waves included in brain waves obtained in a right portion of the forehead (hereinafter referred to as “alpha waves on the right”). It can be estimated that a person feels comfortable when the alpha waves on the left are lower than the alpha waves on the right, and a person feels uncomfortable when the alpha waves on the left are higher than the alpha waves on the right.

Further, when a comfortable or uncomfortable state of a person is estimated using brain waves, an estimation model of, for example, machine learning may also be used instead of deriving a difference in alpha waves included in brain waves between right and left portions of a forehead. This estimation model is, for example, a model that has been caused to learn, as teaching data, alpha or beta waves included in brain waves obtained when a person apparently feels comfortable. When, for example, alpha or beta waves included in brain waves are input to the estimation model, the estimation model estimates a comfortable or uncomfortable state of a person on the basis of the input alpha or beta waves. The estimation model includes, for example, a neural network. The learning model may include, for example, a deep neural network such as a convolutional neural network (CNN).

### (Sweating)

Mental sweating is sweating released from an eccrine gland due to sympathetic tone and caused due to mental or psychological issues such as stress, tension, and anxiety. For example, a sweat measuring probe is attached to a hand palm or a bottom of a foot to measure sweating (mental sweating) induced by various load stimuli on the hand palm or the bottom of the foot. This makes it possible to acquire a sympathetic sweat response (SSwR) in the form of a signal voltage. It can be estimated that a person is feeling comfortable when a numerical value, of a specified high-frequency component in the signal voltage, that is obtained from a left hand is larger than a numerical value, of the specified high-frequency component in the signal voltage, that is obtained from a right hand or when a numerical value, of a specified low-frequency component in the signal voltage, that is obtained from the left hand is larger than a numerical value, of the specified low-frequency component in the signal voltage, that is obtained from the right hand. Further, it can be estimated that a person is feeling uncomfortable when a numerical value, of a specified high-frequency component in the signal voltage, that is obtained from a left hand is smaller than a numerical value, of the specified high-frequency component in the signal voltage, that is obtained from a right hand or when a numerical value, of a specified low-frequency component in the signal voltage, that is obtained from the left hand is smaller than a numerical value, of the specified low-frequency component in the signal voltage, that is obtained from the right hand. Furthermore, it can be estimated that a person is feeling comfortable when a value of amplitude in the signal voltage that is obtained from a left hand is larger than a value of amplitude in the signal voltage that is obtained from a right hand. Further, it can be estimated that a person is feeling uncomfortable when a value of amplitude in the signal voltage that is obtained from a left hand is smaller than a value of amplitude in the signal voltage that is obtained from a right hand.

### (Facial Expression)

It is known that a person frowns when a person feels uncomfortable and that there is only a small change in zygomaticus major muscle when a person feels comfortable. As described above, a comfortable or uncomfortable state can be estimated according to facial expression. Thus, for example, an image of a face is captured using a camera, and facial expression is estimated on the basis of moving-image data obtained by the image-capturing. Then, a comfortable or uncomfortable state of a person can be estimated according to facial expression obtained by the estimation. Further, a comfortable or uncomfortable state of a person can also be estimated using an estimation model used to estimate a comfortable or uncomfortable state of a person on the basis of data of a moving image of facial expression. This estimation model is, for example, a model that has been caused to learn, as teaching data, data of a moving image of facial expression of a person when being given pleasant or unpleasant information. When, for example, data of a moving image of facial expression is input to the estimation model, the estimation model estimates a comfortable or uncomfortable state of a person on the basis of the input moving-image data. The estimation model includes, for example, a neural network. The learning model may include, for example, a deep neural network such as a convolutional neural network (CNN).

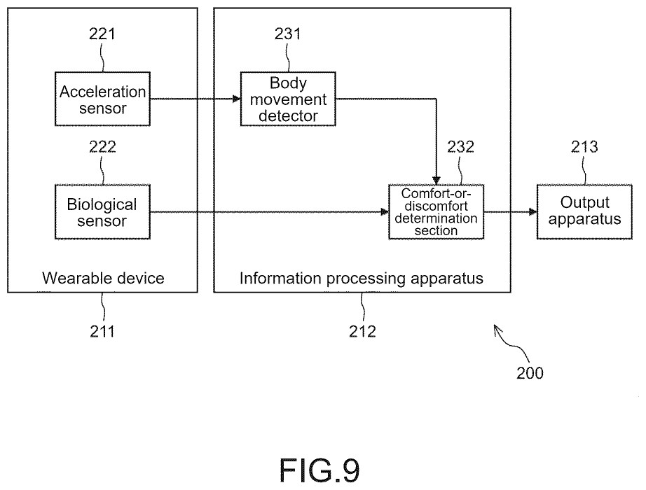

Further, for example, a facial expression myoelectric potential of a specified part of a face is measured, and a comfortable or uncomfortable state of a person can also be estimated using an estimation model used to estimate a comfortable or uncomfortable state of a person on the basis of a value of the measurement. This estimation model is, for example, a model that has been caused to learn, as teaching data, data obtained by measuring a facial expression myoelectric potential of a face of a person when being given pleasant or unpleasant information. When a facial expression myoelectric potential of a specified part of a face of a person is input to the estimation model, the estimation model estimates a comfortable or uncomfortable state of the person on the basis of the input facial expression myoelectric potential. The estimation model includes, for example, a neural network. The learning model may include, for example, a deep neural network such as a convolutional neural network (CNN).
For example, the following document discloses frequency components of brain waves.
   Wang, Xiao-Wei, Dan Nie, and Bao-Liang Lu. “EEG-based emotion recognition using frequency domain features and support vector machines.” International conference on neural information processing. Springer, Berlin, Heidelberg, 2011.
For example, the following document discloses an estimation model using brain waves.
   WO 2021/210607
For example, the following documents disclose sweating.
   Jing Zhai, A. B. Barreto, C. Chin and Chao Li, “Realization of stress detection using psychophysiological signals for improvement of human-computer interactions,” Proceedings. IEEE SoutheastCon, 2005., Ft. Lauderdale, FL, USA, 2005, pp. 415-420, doi: 10.1109/SECON.2005.1423280.
   Boucsein, Wolfram. Electrodermal activity. Springer Science & Business Media, 2012.
For example, the following document discloses heart rate.
   Veltman, J. A., and A. W. K. Gaillard. “Physiological indices of workload in a simulated flight task.” Biological psychology 42.3 (1996): 323-342.
For example, the following document discloses an interval of heart rate variability.
   Appelhans, Bradley M., and Linda J. Luecken. “Heart rate variability as an index of regulated emotional responding.” Review of general psychology 10.3 (2006): 229-240.
For example, the following document discloses an amount of salivary cortisol.
   Lam, Suman, et al. “Emotion regulation and cortisol reactivity to a social-evaluative speech task.” Psychoneuroendocrinology 34.9 (2009): 1355-1362.
For example, the following document discloses facial expression.
   Lyons, Michael J., Julien Budynek, and Shigeru Akamatsu. “Automatic classification of single facial images.” IEEE transactions on pattern analysis and machine intelligence 21.12 (1999): 1357-1362.
For example, the following document discloses muscles of facial expression.
   Ekman, Paul. “Facial action coding system.” (1977).
For example, the following document discloses frequentness of blink.
   Chen, Siyuan, and Julien Epps. “Automatic classification of eye activity for cognitive load measurement with emotion interference.” Computer methods and programs in biomedicine 110.2 (2013): 111-124.
For example, the following document discloses a respiratory volume/a breathing rate.
   Zhang Q., Chen X., Zhan Q., Yang T., Xia S. Respiration-based emotion recognition with deep learning. Comput. Ind. 2017; 92-93:84-90. doi: 10.1016/j. compind.2017.04.005.
For example, the following document discloses a temperature of a skin surface.
   Nakanishi R., Imai-Matsumura K. Facial skin temperature decreases in infants with joyful expression. Infant Behav. Dev. 2008; 31:137-144. doi: 10.1016/j.infbeh.2007.09.001.
For example, the following document discloses multimodality.
   Choi J.-S., Bang J., Heo H., Park K. Evaluation of Fear Using Nonintrusive Measurement of Multimodal Sensors. Sensors. 2015; 15:17507-17533. doi: 10.3390/s150717507.
      (Block Diagram) FIG. 9 is a block diagram of an example of a configuration of an information processing system of a third embodiment, where the present technology is applied to the information processing system.

An information processing system 200 of the third embodiment that is illustrated in FIG. 9 includes a wearable device 211, an information processing apparatus 212, and an output apparatus 213.

The wearable device 211 includes an acceleration sensor 221 and a biological sensor 222. The wearable device 211 is, for example, an earphone, headphones, a headset, a head-mounted display (HMD), smart glasses, or a mask. The wearable device 111 may be attached to a user in the form of glasses, an earring, a hair ornament, a mask, a finger ring, a headband, a wristband, or a chest band. Specific examples of the wearable device 211 will be described later with reference to FIGS. 13 to 20.

The acceleration sensor 221 detects movement of a body of a user in the form of acceleration, and outputs data of the detected acceleration to the information processing apparatus 112 as sensor data. Likewise, the acceleration sensor 221 is an example of a sensor that can detect movement of a body of a user, and is similar to the acceleration sensor of the second embodiment in being replaceable by a sensor (such as a gyroscope, a speed sensor, or an image sensor) other than the acceleration sensor 121.

For example, the biological sensor 222 may be a sensor that is brought into contact with a user, or may be a sensor that is not brought into contact with the user. For example, the biological sensor 222 is a sensor that acquires biological information (biological data) regarding at least one of a brain wave, sweating, a pulse wave, an electrocardiogram, a blood flow, a skin temperature, a facial expression myoelectric potential, an electrooculogram, or a specific component contained in saliva. The biological sensor 222 outputs the acquired piece of biological information to the information processing apparatus 112.

The information processing apparatus 212 includes a body movement detector 231 and a comfort-or-discomfort determination section 232.

The body movement detector 231 acquires acceleration supplied by the acceleration sensor 221 of the wearable device 211 as sensor data, and accumulates the acquired accelerations for a specified period of time. The body movement detector 231 calculates, as movement of a body of a user, an average of the acquired accelerations accumulated for a specified period of time, and supplies the calculated average to the comfort-or-discomfort determination section 232. When acceleration supplied by the acceleration sensor 221 is updated, acceleration that corresponds to data representing movement of a body of a user is also updated in the body movement detector 231.

The comfort-or-discomfort determination section 232 includes a biological distinction model used to determine a comfortable or uncomfortable state of a person using biological information supplied by the biological sensor 222. The comfort-or-discomfort determination section 232 determines a comfortable or uncomfortable state of a user using the biological distinction model, and movement of a body of the user in the form of acceleration supplied by the body movement detector 231. For example, the comfort-or-discomfort determination section 232 calculates estimation probabilities of estimations of a comfortable state and an uncomfortable state that are performed using a biological distinction model and estimation probabilities of estimations of a comfortable state and an uncomfortable state that are performed using an acceleration distinction model. Then, the comfort-or-discomfort determination section 232 calculates an average of the estimation probabilities of estimations of the comfortable state and an average of the estimation probabilities of estimations of the uncomfortable state, and determines a state with a higher estimation probability as a comfortable or uncomfortable state of the user. The comfort-or-discomfort determination section 232 outputs a result of the determination of the comfortable or uncomfortable state to the output apparatus 213.

The output apparatus 213 performs a specified output based on a determination result supplied by the comfort-or-discomfort determination section 232 of the information processing apparatus 212. The output apparatus 213 is similar to the output apparatus 113 of the second embodiment, and thus the description thereof is omitted.

### (Flowchart of Third Comfort-or-Discomfort Determination Processing)

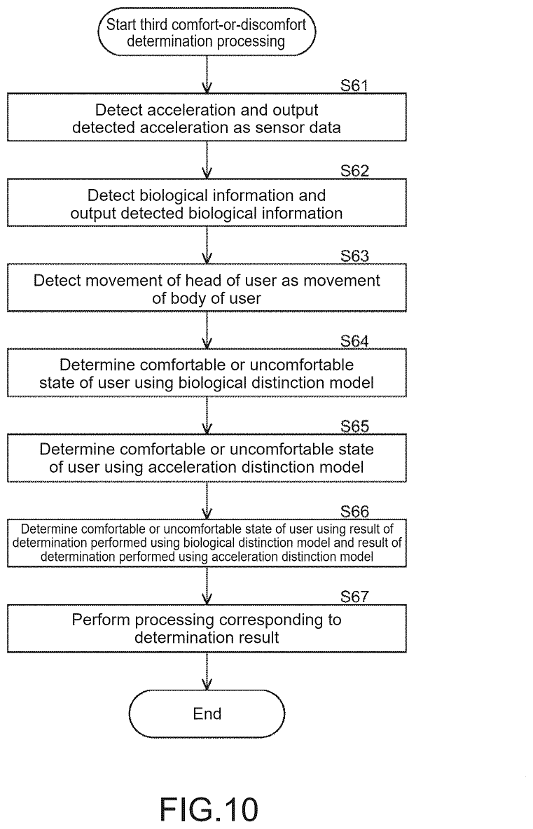

Next, third comfort-or-discomfort determination processing performed by the information processing system 200 is described with reference to a flowchart in FIG. 10. For example, this processing is started when the information processing system 200 is turned on or when an operation to start the comfort-or-discomfort determination processing is performed by a user.

First, in Step S61, the acceleration sensor 221 of the wearable device 211 detects movement of a body of a user in the form of acceleration, and outputs the detected acceleration to the body movement detector 231 of the information processing apparatus 212 as sensor data.

In Step S62, the biological sensor 222 of the wearable device 211 detects biological information regarding the user, and outputs the detected biological information to the comfort-or-discomfort determination section 232 of the information processing apparatus 112. Examples of the biological information include data (biological data) of, for example, brain waves, sweating, pulse waves, an electrocardiogram, a blood flow, a skin temperature, and facial expression myoelectric potential.

In Step S63, the body movement detector 231 of the information processing apparatus 212 detects movement of a head of the user as the movement of the body using the acceleration supplied by the acceleration sensor 221. Data of the acceleration indicating the detected movement of the head is supplied to the comfort-or-discomfort determination section 232.

In Step S64, the comfort-or-discomfort determination section 232 determines a comfortable or uncomfortable state of the user using a biological distinction model used to determine a comfortable or uncomfortable state of a person using biological information. A probability of estimating each of a comfortable state and an uncomfortable state is calculated using the biological distinction model.

In Step S65, the comfort-or-discomfort determination section 232 determines a comfortable or uncomfortable state of the user using an acceleration distinction model used to determine a comfortable or uncomfortable state of a person using the movement (acceleration) of the head of the user, the movement of the head being the movement of the body. Likewise, a probability of estimating each of a comfortable state and an uncomfortable state is calculated using the acceleration distinction model.

In Step S66, the comfort-or-discomfort determination section 232 determines a comfortable or uncomfortable state of the user using a result of the determination performed using the biological distinction model and a result of the determination performed using the acceleration distinction model. For example, an average of the estimation probabilities is calculated for each of a comfortable state and an uncomfortable state, and determines, as a state of the user, the comfortable state or uncomfortable state with a higher degree of probability in estimation. The comfort-or-discomfort determination section 232 outputs a result of the determination of the comfortable or uncomfortable state to the output apparatus 213.

In Step S67, the output apparatus 213 performs processing corresponding to the determination result supplied by the comfort-or-discomfort determination section 232 of the information processing apparatus 212. When, for example, the output apparatus 213 is a display apparatus, the output apparatus 213 displays thereon a message image of, for example, “comfortable state” or “uncomfortable state.”

The third comfort-or-discomfort determination processing is performed as described above. This third comfort-or-discomfort determination processing may be performed repeatedly until an operation to terminate the processing is performed by the user.

In the third comfort-or-discomfort determination processing described above, a distinction model (a first distinction model) using biological information regarding a user, and a distinction model (a second distinction model) using movement of a body of the user (acceleration) are separately provided, and the comfort-or-discomfort determination section 232 outputs determination results using the respective models. However, with respect to the movement of a body of a user, it may be determined, without using a distinction model, whether detected acceleration is greater than or less than a specified threshold, as in the case of the first comfort-or-discomfort determination processing and second comfort-or-discomfort determination processing described above, and determination may be performed by adding acceleration information to the distinction model using biological information regarding a user. For example, in the case in which a user is determined to be in a comfortable state using a distinction model using biological information regarding the user, the comfort-or-discomfort determination section 232 determines, when detected acceleration is less than or equal to a specified threshold, that a final determination result is not a comfortable state, and the comfort-or-discomfort determination section 232 only determines, when the detected acceleration is greater than the specified threshold, that the final determination result is a comfortable state. On the other hand, in the case in which a user is determined to be in an uncomfortable state using a distinction model using biological information regarding the user, the comfort-or-discomfort determination section 232 determines, when detected acceleration is greater than a specified threshold, that a final determination result is not an uncomfortable state, and the comfort-or-discomfort determination section 232 only determines, when the detected acceleration is less than or equal to the specified threshold, that the final determination result is an uncomfortable state. The use of a distinction model using biological information makes it possible to achieve a high degree of accuracy in estimation and to perform detailed chronological estimation (to chronologically output data of a comfortable or uncomfortable state per second). The addition of body-movement data (acceleration) to a distinction model using biological information makes it possible to perform detailed chronological estimation and to achieve a high degree of accuracy in estimation.

### (Flowchart of Fourth Comfort-or-Discomfort Determination Processing)

In the third comfort-or-discomfort determination processing described above, a distinction model (the first distinction model) using biological information regarding a user, and a distinction model (the second distinction model) using movement of a body of the user (acceleration) are separately provided, and determination results using the respective models are output to be integrated. On the other hand, a single distinction model using both biological information regarding a user and movement of a body of the user (acceleration) may be generated, and a comfortable or uncomfortable state may be determined using the single distinction model. For example, this distinction model is generated by causing biological information (such as alpha or beta waves included in brain waves) regarding a person and data of acceleration indicating movement of a body of the person to be learned as teaching data. When, for example, biological information regarding a user and data of acceleration indicating movement of a body of the user are input to the distinction model, the distinction model determines a comfortable or uncomfortable state of a person on the basis of the input biological information and acceleration data. The distinction model includes, for example, a neural network. The learning model may include, for example, a deep neural network such as a convolutional neural network (CNN).

Further, when a plurality of distinction models is used, distinction models using biological information regarding a user may be selectively used depending on a magnitude of movement of a body of the user, without separately performing determination using a distinction model using biological information regarding a user and determination using a distinction model using movement of a body of the user.

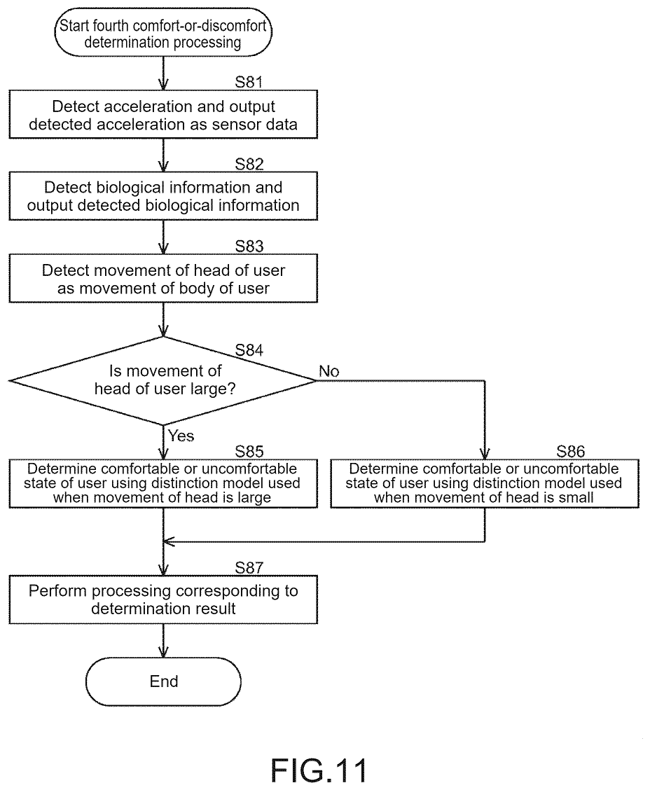

A flowchart in FIG. 11 is a flowchart of fourth comfort-or-discomfort determination processing performed to determine a comfortable or uncomfortable state by selectively using, depending on a magnitude of movement of a body of a user, two distinction models using biological information regarding the user. For example, this processing is started when the information processing system 200 is turned on or when an operation to start the comfort-or-discomfort determination processing is performed by a user.

First, in Step S81, the acceleration sensor 221 of the wearable device 211 detects movement of a body of a user in the form of acceleration, and outputs the detected acceleration to the body movement detector 231 of the information processing apparatus 212 as sensor data.

In Step S82, the biological sensor 222 of the wearable device 211 detects biological information regarding the user (such as brain waves), and outputs the detected biological information to the comfort-or-discomfort determination section 232 of the information processing apparatus 112.

In Step S83, the body movement detector 231 of the information processing apparatus 212 detects movement of a head of the user as the movement of the body using the acceleration supplied by the acceleration sensor 221. The acceleration indicating the detected movement of the head is supplied to the comfort-or-discomfort determination section 232.

In Step S84, the comfort-or-discomfort determination section 232 determines whether the movement of the head of the user is large. For example, when the acceleration being supplied by the body movement detector 231 and indicating the movement of the head is greater than a specified threshold The, the comfort-or-discomfort determination section 232 determines that the movement of the head is large, and when the acceleration is less than or equal to the specified threshold The, the comfort-or-discomfort determination section 232 determines that the movement of the head is small.

When the movement of the head of the user has been determined to be large in Step S84, the process moves on to Step S85, and the comfort-or-discomfort determination section 232 determines a comfortable or uncomfortable state of the user using a distinction model that has performed learning using teaching data used when the movement of the head of the user is large. A result of the determination on a comfortable or uncomfortable state is output to the output apparatus 213.

On the other hand, when the movement of the head of the user has been determined to be small in Step S84, the process moves on to Step S86, and the comfort-or-discomfort determination section 232 determines a comfortable or uncomfortable state of the user using a distinction model that has performed learning using teaching data used when the movement of the head of the user is small. A result of the determination on a comfortable or uncomfortable state is output to the output apparatus 213.

In Step S87, the output apparatus 213 performs processing corresponding to the determination result supplied by the comfort-or-discomfort determination section 232 of the information processing apparatus 212. When, for example, the output apparatus 213 is a display apparatus, the output apparatus 213 displays thereon a message image of, for example, “comfortable state” or “uncomfortable state.”

The fourth comfort-or-discomfort determination processing is performed as described above. This fourth comfort-or-discomfort determination processing may be performed repeatedly until an operation to terminate the processing is performed by the user.

### 5. Modification of Third Embodiment

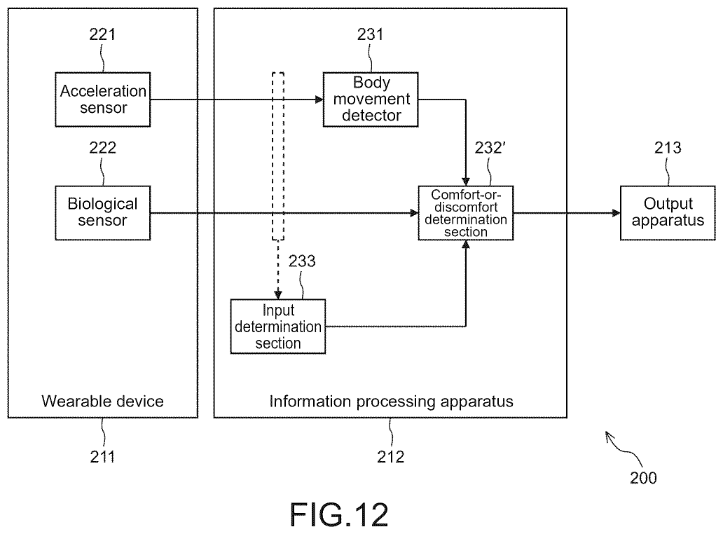

FIG. 12 is a block diagram of an example of a configuration of the information processing system according to a modification of the third embodiment.

The information processing system 200 illustrated in FIG. 12 is configured to switch comfortable or uncomfortable state determining processing depending on the type of sensor included in a wearable device 211X connected to the information processing apparatus 212. In the example illustrated in FIG. 12, the wearable device 211 similar to the wearable device 211 of the third embodiment illustrated in FIG. 9 is connected to the information processing apparatus 212 as the wearable device 211X.

The information processing system 200 illustrated in FIG. 12 is in common with the information processing system 200 of the third embodiment illustrated in FIG. 9 in including the wearable device 211, the information processing apparatus 212, and the output apparatus 213. On the other hand, the information processing system 200 illustrated in FIG. 12 is different from the information processing system 200 of the third embodiment illustrated in FIG. 9 in that an input determination section 233 is newly provided to the information processing apparatus 212.

The information processing apparatus 212 includes the body movement detector 231, a comfort-or-discomfort determination section 232′, and the input determination section 233. The input determination section 233 determines the type of data input to the information processing apparatus 212, and supplies a result of the determination to the comfort-or-discomfort determination section 232′. For example, the input determination section 233 detects the data input to the information processing apparatus 212 to determine the type of the data.

Alternatively, the information processing apparatus 212 may include a plurality of operation modes respectively corresponding to the types of pieces of inputtable data, and the input determination section 233 may cause a user to select an operation mode corresponding to data outputtable by the wearable device 211X connected to the information processing apparatus 212 to determine the type of the data.

When, for example, the wearable device 211X connected to the information processing apparatus 212 is the wearable device 211 being the same as the wearable device 211 of the third embodiment illustrated in FIG. 9 and including both the acceleration sensor 221 and the biological sensor 222, as illustrated in FIG. 12, the comfort-or-discomfort determination section 232′ determines a comfortable or uncomfortable state of a user using data of acceleration corresponding to detected movement of a head of the user and biological information regarding the user, as in the case of the comfort-or-discomfort determination section 232 illustrated in FIG. 9.

On the other hand, when the wearable device 211X connected to the information processing apparatus 212 is the wearable device 111 (FIG. 8) only including the acceleration sensor 121, the comfort-or-discomfort determination section 232′ determines a comfortable or uncomfortable state of a user only using acceleration supplied by the body movement detector 231, as in the case of the comfort-or-discomfort determination section 23 of the second embodiment illustrated in FIG. 8.

Alternatively, when the wearable device 211X connected to the information processing apparatus 212 is a wearable device that only includes the biological sensor 222, the comfort-or-discomfort determination section 232′ determines a comfortable or uncomfortable state of a user only using biological information supplied by the biological sensor 222.

As described above, the information processing system 200 according to the modification of the third embodiment makes it possible to determine a comfortable or uncomfortable state of a user by switching the comfortable or uncomfortable state determining processing (an operation mode) depending on the type of input data input to the information processing apparatus 212. For example, switching between an operation of simply estimating a comfortable or uncomfortable state only using a magnitude of body movement, and an operation of estimating a comfortable or uncomfortable state in a detailed chronological order with a high degree of accuracy using the magnitude of body movement and biological information can be performed depending on the type of input data.

### 6. Examples of Wearable Devices

FIGS. 13 to 20 each illustrate an example of a device that can be used as the wearable device 111 or wearable device 211 described above.

FIG. 13 illustrates an example of a head-mounted display (HMD).

A head-mounted display 300 includes at least a pad portion 301 and a band portion 302. For example, at least one sensor 303 is provided to a specified portion of the pad portion 301 or band portion 302. When the head-mounted display 300 is the wearable device 111 described above, the sensor 303 is a sensor used to detect movement of a body of a user. When the head-mounted display 300 is the wearable device 211 described above, a plurality of sensors 303 including a sensor used to detect movement of a body of a user and a sensor used to acquire biological information is provided.

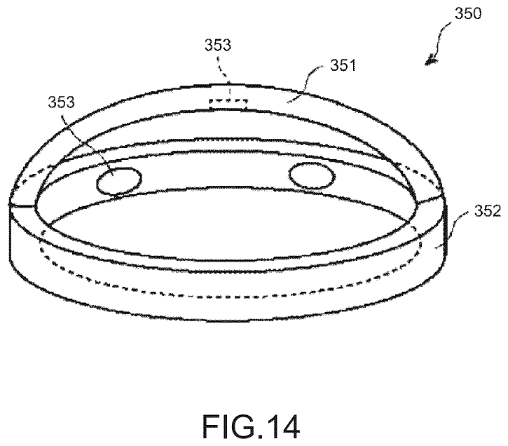

FIG. 14 illustrates an example of a headband.

A headband 350 includes band portions 351 and 352 that are brought into contact with a head. For example, at least one sensor 353 is provided to a specified portion of the band portion 351 or 352. When the headband 350 is the wearable device 111 described above, the sensor 353 is a sensor used to detect movement of a body of a user. When the headband 350 is the wearable device 211 described above, a plurality of sensors 353 including a sensor used to detect movement of a body of a user and a sensor used to acquire biological information is provided.

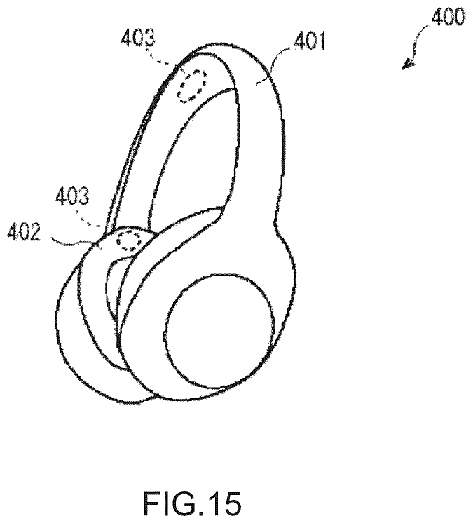

FIG. 15 illustrates an example of headphones.

Headphones 400 include a band portion 401 that is brought into contact with a head, and ear pads 402 that are each brought into contact with an ear. For example, at least one sensor 403 is provided to a specified portion of the band portion 401 or ear pad 402. When the headphones 400 are the wearable device 111 described above, the sensor 403 is a sensor used to detect movement of a body of a user. When the headphones 400 are the wearable device 211 described above, a plurality of sensors 403 including a sensor used to detect movement of a body of a user and a sensor used to acquire biological information is provided.

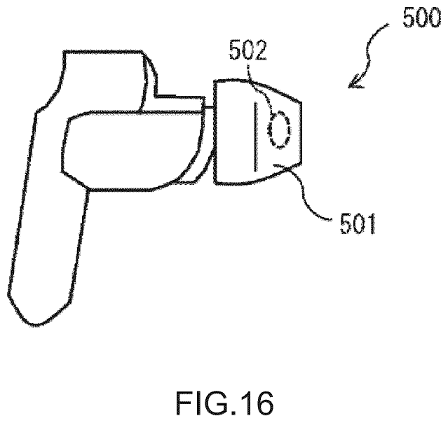

FIG. 16 illustrates an example of an earphone.

An earphone 500 includes an earpiece 501 that is inserted into an ear. For example, at least one sensor 502 is provided to a specified portion of the earpiece 501. When the earphone 500 is the wearable device 111 described above, the sensor 502 is a sensor used to detect movement of a body of a user. When the earphone 500 is the wearable device 211 described above, a plurality of sensors 502 including a sensor used to detect movement of a body of a user and a sensor used to acquire biological information is provided.

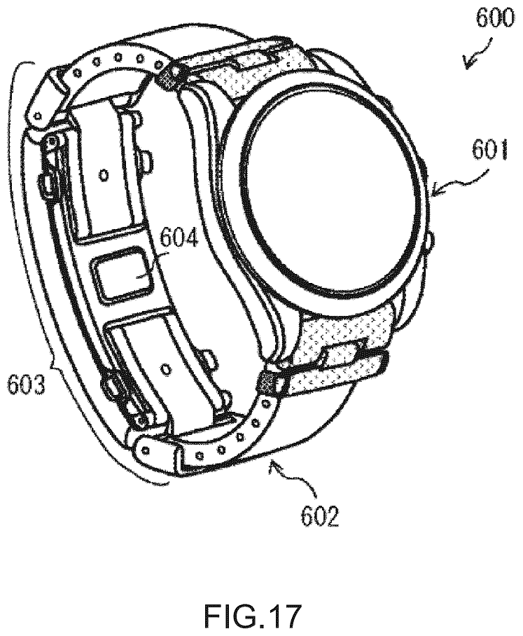

FIG. 17 illustrates an example of a watch.

A watch 600 includes a display section 601 that displays thereon, for example, a time, a band portion 602, and a buckle portion 603. For example, at least one sensor 604 is provided to a specified portion of the buckle portion 603. When the watch 600 is the wearable device 111 described above, the sensor 604 is a sensor used to detect movement of a body of a user. When the watch 600 is the wearable device 211 described above, a plurality of sensors 604 including a sensor used to detect movement of a body of a user and a sensor used to acquire biological information is provided.

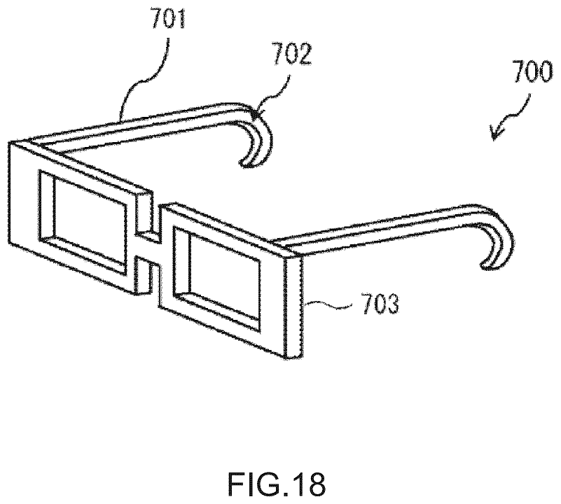

FIG. 18 illustrates smart glasses (glasses).

Smart glasses 700 include temple portions 701 that are each engaged with an ear, and a lens frame portion 703 that supports lenses. For example, at least one sensor 702 is provided to a specified portion of the temple portion 701. When the smart glasses 700 are the wearable device 111 described above, the sensor 702 is a sensor used to detect movement of a body of a user. When the smart glasses 700 are the wearable device 211 described above, a plurality of sensors 702 including a sensor used to detect movement of a body of a user and a sensor used to acquire biological information is provided.

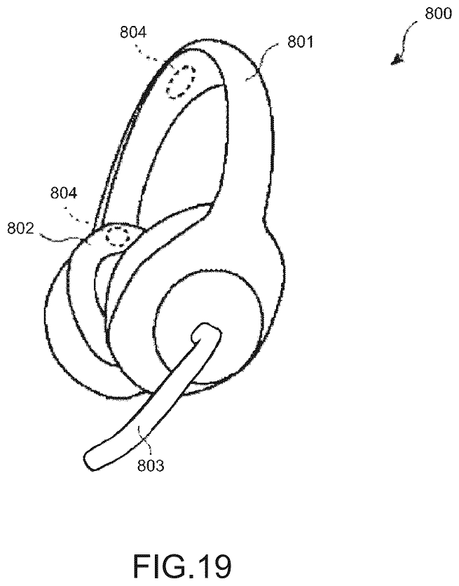

FIG. 19 illustrates an example of a headset.

A headset 800 includes a band portion 801 that is brought into contact with a head, ear pads 802 that are each brought into contact with an ear, and a microphone portion 803 that includes a built-in microphone. For example, at least one sensor 804 is provided to a specified portion of the band portion 801 or ear pad 802. When the headset 800 is the wearable device 111 described above, the sensor 804 is a sensor used to detect movement of a body of a user.

When the headset 800 is the wearable device 211 described above, a plurality of sensors 804 including a sensor used to detect movement of a body of a user and a sensor used to acquire biological information is provided.

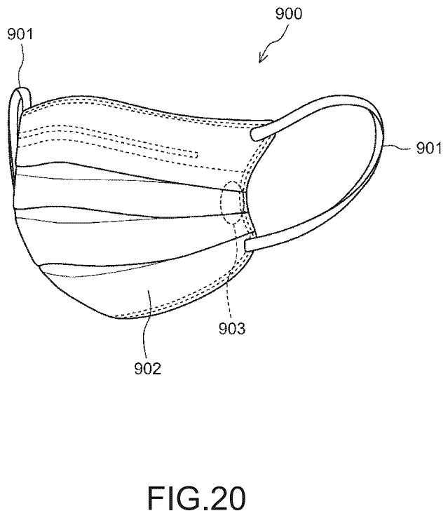

FIG. 20 illustrates an example of a mask.

A mask 900 includes ear strings 901 that are each engaged with an ear, and a body 902 that covers a nose and a mouse. For example, at least one sensor 903 is provided to a specified portion of the body 902. When the mask 900 is the wearable device 111 described above, the sensor 903 is a sensor used to detect movement of a body of a user. When the mask 900 is the wearable device 211 described above, a plurality of sensors 903 including a sensor used to detect movement of a body of a user and a sensor used to acquire biological information is provided.

### 7. Example of Configuration of Computer

The series of processes described above may be performed using hardware or software. When the series of processes is performed using software, a program included in the software is installed on a computer. Here, examples of the computer include a microcomputer incorporated into dedicated hardware, and a computer such as a general-purpose personal computer that can perform various functions by various programs being installed thereon.

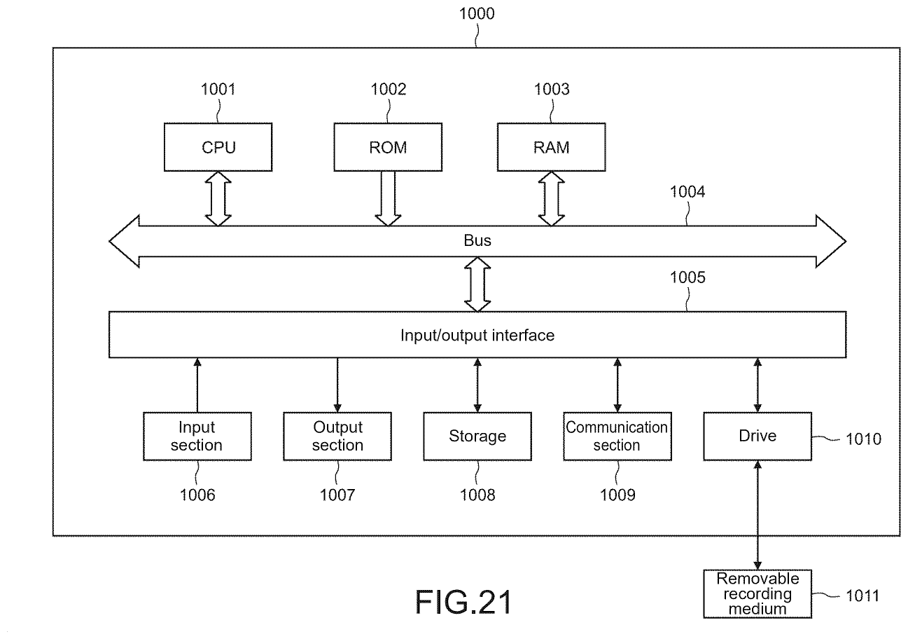

FIG. 21 is a block diagram of an example of a hardware configuration when the information processing apparatus 1, 112, or 212 described above includes a computer.

A computer 1000 includes a central processing unit (CPU) 1001, a read only memory (ROM) 1002, and a random access memory (RAM) 1003. The CPU 1001, the ROM 1002, and the RAM 1003 are connected to each other through a bus 1004. Further, an input/output interface 1005 is connected to the bus 1004. An input section 1006, an output section 1007, a storage 1008, a communication section 1009, and a drive 1010 are connected to the input/output interface 1005.

The input section 1006 includes, for example, a keyboard, a mouse, a microphone, a touchscreen, and an input terminal. The output section 1007 includes, for example, a display, a speaker, and an output terminal. The storage 1008 includes, for example, a hard disk, a solid state drive (SSD), a RAM disk, and a nonvolatile memory. The communication section 1009 includes, for example, a network interface. The drive 1010 drives a removable recording medium 1011 such as a magnetic disk, an optical disk, a magneto-optical disk, or a semiconductor memory.

In the computer having the configuration described above, the series of processes described above is performed by the CPU 1001 loading, for example, a program stored in the storage 1008 into the RAM 1003 and executing the program via the input/output interface 1005 and the bus 1004. Data necessary for the CPU 1001 to perform various processes is also stored in the RAM 1003 as necessary.

For example, the program executed by the computer (the CPU 1001) may be provided by being recorded in the removable recording medium 1011 serving as, for example, a package medium. Further, the program may be provided via a wired or wireless transmission medium such as a local area network, the Internet, or digital satellite broadcasting.

In the computer, the program may be installed on the storage 1008 via the input/output interface 1005 by the removable recording medium 1011 being mounted on the drive 1010. Further, the program may be received by the communication section 1009 via the wired or wireless transmission medium to be installed on the storage 1008. Moreover, the program may be installed in advance on the ROM 1002 or the storage 1008.

The program executed by the computer may be a program in which processes are chronologically performed in the order of the description herein, or may be a program in which processes are performed in parallel or a process is performed at a necessary timing such as a timing of calling.

Note that the system as used herein refers to a collection of a plurality of components (such as apparatuses and modules (parts)) and it does not matter whether all of the components are in a single housing. Thus, a plurality of apparatuses accommodated in separate housings and connected to one another via a network, and a single apparatus in which a plurality of modules is accommodated in a single housing are both systems.

The embodiment of the present disclosure is not limited to the examples described above, and various modifications may be made thereto without departing from the scope of the technology of the present disclosure. For example, a combination of all of, or a combination of a portion of the embodiments described above may be adopted.

For example, the technology of the present disclosure may have a configuration of cloud computing in which a single function is shared to be cooperatively processed by a plurality of apparatuses via a network.

Further, the respective steps described using the flowcharts described above may be performed by a single apparatus, or may be shared to be performed by a plurality of apparatuses. Moreover, when a single step includes a plurality of processes, the plurality of processes included in the single step may be performed by a single apparatus, or may be shared to be performed by a plurality of apparatuses.

The effects described herein are not limitative but are merely illustrative, and an effect other than the effects described herein may be provided.

Note that the technology of the present disclosure may adopt the following configurations.
(1) An information processing apparatus, including:
   a detector that detects movement of a body of a person using data obtained by a sensor; and
   a determination section that determines a comfortable or uncomfortable state of the person on the basis of the detected body movement.
(2) The information processing apparatus according to (1), in which
   the detector detects the movement of the body of the person in a form of acceleration.
(3) The information processing apparatus according to (1) or (2), in which
   the detector detects acceleration of a head of the person as the movement of the body of the person.
(4) The information processing apparatus according to any one of (1) to (3), in which
   the determination section specifies a period of time for which the person is speaking, and determines the comfortable or uncomfortable state of the person on the basis of the body movement during the speech.
(5) The information processing apparatus according to any one of (1) to (4), in which
   the determination section determines the comfortable or uncomfortable state of the person according to a magnitude of the body movement.
(6) The information processing apparatus according to any one of (1) to (5), in which
   the detector detects the body movement in a form of acceleration, and
   the determination section determines the comfortable or uncomfortable state of the person by comparing the acceleration to a specified threshold.
(7) The information processing apparatus according to (6), in which
   when the acceleration is greater than the specified threshold, the determination section determines that the person is in a comfortable state, and
   when the acceleration is less than or equal to the specified threshold, the determination section determines that the person is in an uncomfortable state.
(8) The information processing apparatus according to (6), in which
   the determination section uses a first threshold and a second threshold that are different from each other, the first threshold being used to determine whether the person is in a comfortable state, the second threshold being used to determine whether the person is in an uncomfortable state.
(9) The information processing apparatus according to (8), in which
   the first threshold is greater than the second threshold,
   when the acceleration is greater than the first threshold, the determination section determines that the person is in a comfortable state, and
   when the acceleration is less than or equal to the second threshold, the determination section determines that the person is in an uncomfortable state.
(10) The information processing apparatus according to any one of (6) to (9), in which the specified threshold is determined on the basis of an AUC.
(11) The information processing apparatus according to any one of (6) to (10), in which
   the specified threshold is updated on the basis of past data indicating the movement of the body of the person.
(12) The information processing apparatus according to any one of (1) to (11), in which
   the sensor is an acceleration sensor attached to the person, and
   the detector detects the movement of the body of the person on the basis of the data supplied by the acceleration sensor.
(13) The information processing apparatus according to any one of (1) to (11), in which
   the sensor is an image sensor that captures an image of the person, and
   the detector detects the movement of the body of the person by detecting acceleration of the person on the basis of image data obtained supplied by the image sensor.
(14) The information processing apparatus according to any one of (1) to (13), in which
   the determination section determines the comfortable or uncomfortable state of the person using the body movement detected by the detector, and a distinction model used to determine the comfortable or uncomfortable state based on biological information regarding the person.
(15) The information processing apparatus according to any one of (1) to (14), further including
   an input determination section that determines a type of data obtained by at least one of the sensors and input to the information processing apparatus, in which
   the determination section determines the comfortable or uncomfortable state of the person using the data obtained by the at least one of the sensors.
(16) The information processing apparatus according to any one of (1) to (15), further including
   an output section that performs a specified output based on a result of the determination performed by the determination section.
(17) The information processing apparatus according to (16), in which
   the output section outputs instruction information regarding an instruction given to the person, the instruction information being based on a result of the determination performed by the determination section.
(18) An information processing system, including:
   A device that includes a sensor;
   a detector that detects movement of a body of a person using data obtained by the sensor;
   a determination section that determines a comfortable or uncomfortable state of the person on the basis of the detected body movement; and
   an output section that performs a specified output based on a result of the determination.

### REFERENCE SIGNS LIST

1 information processing apparatus
21 sensor
22 body movement detector
23 comfort-or-discomfort determination section
24 output section
51 camera
52 microphone
53 display
61 calling app
100 information processing system
111 wearable device
112 information processing apparatus
113 output apparatus
121 acceleration sensor
200 information processing system
211 wearable device
212 information processing apparatus
213 output apparatus
221 acceleration sensor
222 biological sensor
231 body movement detector
232, 232′ comfort-or-discomfort determination section
233 input determination section
300 head-mounted display
350 headband
400 headphones
500 earphone
600 watch
700 smart glasses
800 headset
900 mask
1000 computer
1001 CPU
1002 ROM
1006 input section
1007 output section
1008 storage
1009 communication section
1010 drive
1011 removable recording medium

What is claimed is:

1. An information processing apparatus, comprising:
a detector that detects movement of a body of a person using data obtained by a sensor; and
a determination section that determines a comfortable or uncomfortable state of the person on a basis of the detected body movement.

2. The information processing apparatus according to claim 1, wherein
the detector detects the movement of the body of the person in a form of acceleration.

3. The information processing apparatus according to claim 1, wherein
the detector detects acceleration of a head of the person as the movement of the body of the person.

4. The information processing apparatus according to claim 1, wherein
the determination section specifies a period of time for which the person is speaking, and determines the comfortable or uncomfortable state of the person on a basis of the body movement during the speech.

5. The information processing apparatus according to claim 1, wherein
the determination section determines the comfortable or uncomfortable state of the person according to a magnitude of the body movement.

6. The information processing apparatus according to claim 1, wherein
the detector detects the body movement in a form of acceleration, and
the determination section determines the comfortable or uncomfortable state of the person by comparing the acceleration to a specified threshold.

7. The information processing apparatus according to claim 6, wherein
when the acceleration is greater than the specified threshold, the determination section determines that the person is in a comfortable state, and
when the acceleration is less than or equal to the specified threshold, the determination section determines that the person is in an uncomfortable state.

8. The information processing apparatus according to claim 6, wherein
the determination section uses a first threshold and a second threshold that are different from each other, the first threshold being used to determine whether the person is in a comfortable state, the second threshold being used to determine whether the person is in an uncomfortable state.

9. The information processing apparatus according to claim 8, wherein
the first threshold is greater than the second threshold,
when the acceleration is greater than the first threshold, the determination section determines that the person is in a comfortable state, and
when the acceleration is less than or equal to the second threshold, the determination section determines that the person is in an uncomfortable state.

10. The information processing apparatus according to claim 6, wherein
the specified threshold is determined on a basis of an AUC.

11. The information processing apparatus according to claim 6, wherein
the specified threshold is updated on a basis of past data indicating the movement of the body of the person.

12. The information processing apparatus according to claim 1, wherein
the sensor is an acceleration sensor attached to the person, and
the detector detects the movement of the body of the person on a basis of the data supplied by the acceleration sensor.

13. The information processing apparatus according to claim 1, wherein
the sensor is an image sensor that captures an image of the person, and
the detector detects the movement of the body of the person by detecting acceleration of the person on a basis of image data obtained supplied by the image sensor.

14. The information processing apparatus according to claim 1, wherein
the determination section determines the comfortable or uncomfortable state of the person using the body movement detected by the detector, and a distinction model used to determine the comfortable or uncomfortable state based on biological information regarding the person.

15. The information processing apparatus according to claim 1, further comprising
an input determination section that determines a type of data obtained by at least one of the sensors and input to the information processing apparatus, wherein
the determination section determines the comfortable or uncomfortable state of the person using the data obtained by the at least one of the sensors.

16. The information processing apparatus according to claim 1, further comprising
an output section that performs a specified output based on a result of the determination performed by the determination section.

17. The information processing apparatus according to claim 16, wherein
the output section outputs instruction information regarding an instruction given to the person, the instruction information being based on a result of the determination performed by the determination section.

18. An information processing system, comprising:
a device that includes a sensor;
a detector that detects movement of a body of a person using data obtained by the sensor;
a determination section that determines a comfortable or uncomfortable state of the person on a basis of the detected body movement; and
an output section that performs a specified output based on a result of the determination.
